(19) United States
(12) Patent Application Publication
(10) Pub. No.: US 2014/0085692 A1
(43) Pub. Date: Mar. 27, 2014

(54) METHOD AND SYSTEM FOR PROCESSING HOLOGRAM DATA USING HOLOGRAM FRINGE DATA FORMAT ADAPTIVE TO DATA ENCODING SCHEME

(71) Applicant: Electronics and Telecommunications Research Institute, Daejeon (KR)

(72) Inventors: Beom Ryeol LEE, Daejeon (KR); Wook Ho SON, Daejeon (KR); Seung Taik OH, Daejeon (KR); Ho Yong SEO, Seoul (KR); Chi Young HWANG, Busan (KR)

(73) Assignee: Electronics and Telecommunications Research Institute, Daejeon (KR)

(21) Appl. No.: 14/036,642

(22) Filed: Sep. 25, 2013

(30) Foreign Application Priority Data
Sep. 27, 2012 (KR) 10-2012-0108066
Apr. 10, 2013 (KR) 10-2013-0039260

(51) Int. Cl. G03H 1/22

(52) U.S. Cl. CPC G03H 1/2202
USPC 359/23

(57) ABSTRACT

A hologram data processing method using a hologram fringe data format adaptive to a data encoding scheme includes configuring model data of a three-dimensional (3D) object corresponding to source data to be used for generating a hologram, computing hologram fringe data by applying a diffraction transform to a light wave transferred to a hologram plane based on the model data of the 3D object, setting, in the computed hologram fringe data, the hologram fringe data format adaptive to a data encoding scheme for reconstructing the hologram, reconstructing an optical hologram by applying the data encoding scheme to the hologram fringe data, and adjusting the optical hologram by comparing a reconstructed image of the optical hologram to a reconstructed image of a numerical hologram.

### CROSS-REFERENCE TO RELATED APPLICATIONS

This application claims the benefit of Korean Patent Application No. 10-2012-0108066, filed on Sep. 27, 2012, and Korean Patent Application No. 10-2013-0039260, filed on Apr. 10, 2013, in the Korean Intellectual Property Office, the disclosures of which are incorporated herein by reference.

### BACKGROUND

1. Field of the Invention

The present invention relates to a method and system for processing hologram data using a hologram fringe data format adaptive to a data encoding scheme, and more particularly, to a technology for setting a hologram fringe data format adaptive to an amplitude encoding scheme and a phase encoding scheme.

2. Description of the Related Art

Hologram data processing refers to a technology for reconstructing an optical hologram from source data to be used for generating a hologram. The optical hologram may be reconstructed by applying data encoding to a spatial light modulator (SLM). Here, a data encoding scheme may include an amplitude encoding scheme and a phase encoding scheme.

### SUMMARY

An aspect of the present invention provides a method, apparatus, and system that may define a data format for storing hologram fringe data.

Another aspect of the present invention also provides a method, apparatus, and system that may set a hologram fringe data format adaptive to a data encoding scheme, by defining a data format adaptive to both an amplitude encoding scheme and a phase encoding scheme in a process of processing hologram data.

Still another aspect of the present invention also provides a method, apparatus, and system that may define a data format to adjust an optical hologram by comparing a reconstructed optical hologram to a numerical hologram in a process of processing hologram data.

According to an aspect of the present invention, there is provided a method of processing hologram data using a hologram fringe data format adaptive to a data encoding scheme, the method including configuring model data of a three-dimensional (3D) object corresponding to source data to be used for generating a hologram, computing hologram fringe data by applying a diffraction transform to a light wave transferred to a hologram plane based on the model data of the 3D object, setting, in the computed hologram fringe data, the hologram fringe data format adaptive to a data encoding scheme for reconstructing the hologram, reconstructing an optical hologram by applying the data encoding scheme to the hologram fringe data, and adjusting the optical hologram by comparing a reconstructed image of the optical hologram to a reconstructed image of a numerical hologram.

The setting may include setting a hologram fringe data format adaptive to both an amplitude encoding scheme and a phase encoding scheme, by incorporating information on phase data of the hologram and information on amplitude data of the hologram into the hologram fringe data format.

The information on the amplitude data of the hologram may include start bit string information on the amplitude data of the hologram, amplitude data type information of the hologram, bit length information of an amplitude data stream of the hologram, and amplitude data stream information of the hologram.

The information on the phase data of the hologram may include start bit string information on the phase data of the hologram, phase data type information of the hologram, bit length information of a phase data stream of the hologram, and phase data stream information of the hologram.

The hologram fringe data format may further include header information including a hologram generation parameter and start bit information of the hologram fringe data.

The header information may include information on a 3D model data configuration scheme, information on a reference beam, information on a hologram fringe pattern data generation parameter, information on a hologram reproduction scheme, and information on an optical parameter.

The adjusting may include adjusting the optical hologram in a direction in which the reconstructed image of the optical hologram matches the reconstructed image of the numerical hologram.

The adjusting may include re-computing the hologram fringe data by adjusting a hologram generation parameter.

According to another aspect of the present invention, there is provided a method of setting a hologram fringe data format adaptive to a data encoding scheme, the method including configuring model data of a 3D object corresponding to source data to be used for generating a hologram, computing hologram fringe data by applying a diffraction transform to a light wave transferred to a hologram plane based on the model data of the 3D object, and setting, in the computed hologram fringe data, the hologram fringe data format adaptive to a data encoding scheme for reconstructing the hologram.

The setting may include setting a hologram fringe data format adaptive to both an amplitude encoding scheme and a phase encoding scheme, by incorporating information on amplitude data of the hologram and information on phase data of the hologram into the hologram fringe data format.

According to still another aspect of the present invention, there is provided a system for processing hologram data using a hologram fringe data format adaptive to a data encoding scheme, the system including a configurator to configure model data of a 3D object corresponding to source data to be used for generating a hologram, a computation unit to compute hologram fringe data by applying a diffraction transform to a light wave transferred to a hologram plane based on the model data of the 3D object, a setting unit to set, in the computed hologram fringe data, the hologram fringe data format adaptive to a data encoding scheme for reconstructing the hologram, a reconstructor to reconstruct an optical hologram by applying the data encoding scheme to the hologram fringe data, and an adjuster to adjust the optical hologram by comparing a reconstructed image of the optical hologram to a reconstructed image of a numerical hologram.

The setting unit may set a hologram fringe data format adaptive to both an amplitude encoding scheme and a phase encoding scheme, by incorporating information on phase data of the hologram and information on amplitude data of the hologram into the hologram fringe data format.

According to yet another aspect of the present invention, there is provided a system for setting a hologram fringe data format adaptive to a data encoding scheme, the system including a configurator to configure model data of a 3D object corresponding to source data to be used for generating a hologram, a computation unit to compute hologram fringe data by applying a diffraction transform to a light wave transferred to a hologram plane based on the model data of the 3D object, and a setting unit to set, in the computed hologram fringe data, the hologram fringe data format adaptive to a data encoding scheme for reconstructing the hologram.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a hologram fringe data format adaptive to a data encoding scheme according to an embodiment of the present invention;

FIG. 2 is a diagram illustrating a relationship between a three-dimensional (3D) object plane and a hologram plane according to an embodiment of the present invention;

FIG. 3 is a diagram illustrating an amplitude encoding scheme according to an embodiment of the present invention;

FIGS. 4A through 4C are diagrams illustrating a phase encoding scheme according to an embodiment of the present invention;

FIG. 5 is a flowchart illustrating a hologram data processing method using a hologram fringe data format adaptive to a data encoding scheme according to an embodiment of the present invention; and

FIG. 6 is a block diagram illustrating a hologram data processing system using a hologram fringe data format adaptive to a data encoding scheme according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

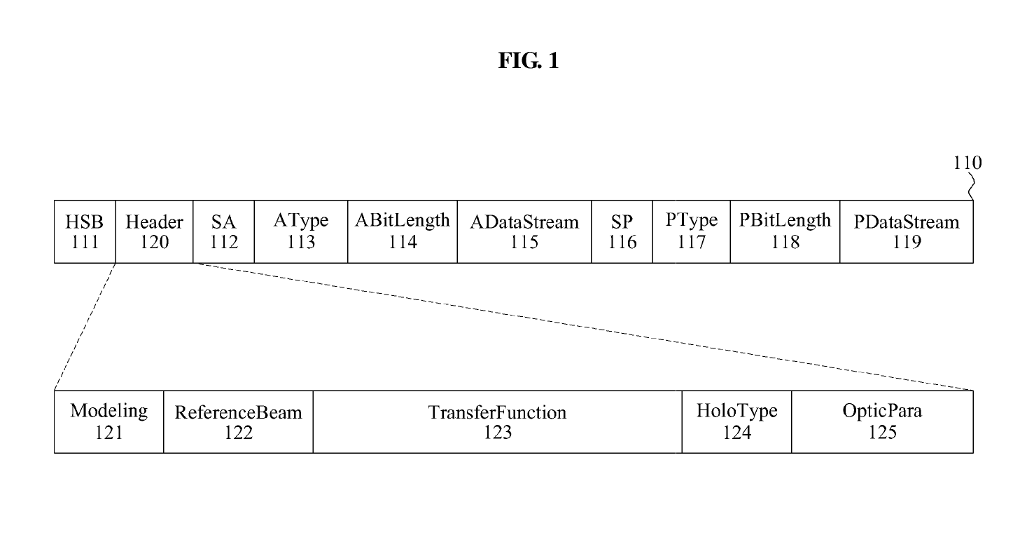

FIG. 1 is a diagram illustrating a hologram fringe data format 110 adaptive to a data encoding scheme according to an embodiment of the present invention.

Referring to FIG. 1, in a process of processing hologram data, the hologram fringe data format 110 may include information on amplitude data of a hologram, and information on phase data of the hologram.

The information on the amplitude data may be stored in formats of SA 112, AType 113, ABitLength 114, and ADataStream 115. Here, the SA 112 may include start bit string information with respect to at least one of real part data and the amplitude data of the hologram. The AType 113 may include type information of the amplitude data of the hologram. The ABitLength 114 may include bit length information of an amplitude data stream of the hologram. The ADataStream 115 may include information on an amplitude data stream of the hologram.

The information on the phase data may be stored in formats of SP 116, PType 117, PBitLength 118, and PDataStream 119. Here, the SP 116 may include start bit string information with respect to at least one of imaginary part data and the phase data of the hologram. The PType 117 may include type information of the phase data of the hologram. The PBitLength 118 may include bit length information of a phase data stream of the hologram. The PDataStream 119 may include information on a phase data stream of the hologram.

In addition, the hologram fringe data format 110 may further include HSB 111, and Header 120. The HSB 111 may correspond to a format in which start bit information of hologram fringe data is stored, and the Header 120 may correspond to a format in which header information including hologram generation parameters is stored.

The header information including the hologram generation parameters will be described by referring to the following Table 1.

TABLE 1

| | | Number | |
|---|---|---|---|
| Association | Hologram generation parameter | of bits | Description |
| 3D model data | Point cloud | 1 | Point cloud modeling |
| configuration | Angular spectrum | | Polygon mesh modeling |
| scheme | | | |
| Reference | Intensity | 8 | Intensity of reference beam |
| beam | Incident angle, Φ | 16 | Incident angle (°) of reference beam |
| | Wave length(color), λ | 16 | Wave length (nm) of reference beam |
| Hologram | Pixel pitch, p | 16 | Pixel pitch (um) |
| fringe pattern | Propagation distance, d | 16 | Distance between object and hologram |
| data generation | Resolution, M × N | 32 | Hologram resolution |
| parameter | SLM Type | 2 | Types of SLM: LCD/LCoS, DMD, AOM) |
| | Fringe Type | 2 | Types of fringe data: amplitude-only, |
| | | | phase-only, interference |
| | Object Size | 16 | Size of 3D object |
| | View angle | 16 | View angle of reconstructed image |
| | Spatial frequency | 16 | Spatial frequency |
| | Hologram file depth | 16 | Hologram file depth |
| Hologram | Hologram rtype 1 | 1 | Hologram reproduction scheme 1: |
| reproduction | | | Transmission/Reflection |
| scheme | Hologram rtype 2 | 1 | Hologram reproduction scheme 2: On- |
| | | | axis/off-axis |
| Optical | Lens para. | 32 | Lens parameters: focal length, diameter |
| parameter | Prism x-y | 32 | Location information of prism |
| | Gamma | 16 | Gamma function value |
| | x-y shift | 32 | x-y axial shift |

| | |
|---|---|
| Total number of bits | 287 |

Referring to Table 1, the header information including the hologram generation parameters may include information on a three-dimensional (3D) model data configuration scheme, information on a reference beam, information on a hologram fringe pattern data generation parameter, information on a hologram reproduction scheme, and information on an optical parameter. Here, the information on the 3D model data configuration scheme may be stored in a format of Modeling 121, and may include information on a point cloud modeling scheme and information on a polygon mesh modeling scheme. The information on the reference beam may be stored in a format of ReferenceBeam 122. The information on the hologram fringe pattern data generation parameter may be stored in a format of TransferFunction 123. The information on the hologram reproduction scheme may be stored in a format of HoloType 124. The information on the optical parameter including information on Lens parameters may be stored in a format of OpticPara 125.

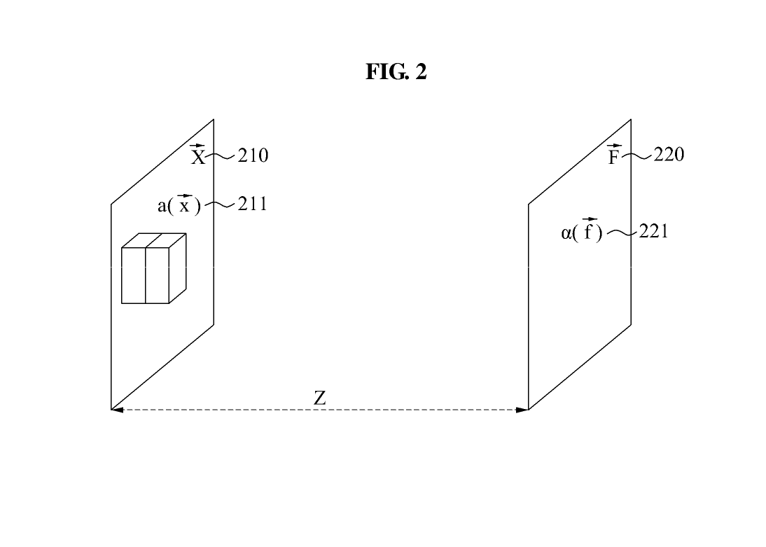

A hologram data processing method according to an embodiment of the present invention may be adaptive to both an amplitude encoding scheme and a phase encoding scheme, by setting a hologram fringe data format in which both information on amplitude data of a hologram and information on phase data of the hologram are included in hologram fringe data. Computation of the hologram fringe data for which the hologram fringe data format is set will be described with reference to FIG. 2.

FIG. 2 is a diagram illustrating a relationship between a 3D object plane 210 and a hologram plane 220 according to an embodiment of the present invention.

Referring to FIG. 2, the 3D object plane 210 and the hologram plane 220 are illustrated. A relationship between a function α(\vec{x})α(\vec{x}) 221 representing the hologram plane 220 and a function a(\vec{x}) 211 representing the 3D object plane 210 may be expressed by Equation 1.

$$α ( {x}^{->} ) = {\int }_{{x}^{->}}^{ } a ( {x}^{->} ) {T}_{z} ( {x}^{->} , {f}^{->} ) d {x}^{->} \qquad [ Equation 1 ]$$

The relationship between the 3D object plane 210 and the hologram plane 220 may be expressed by a diffraction component with respect to a light wave transferred from model data of the 3D object to the hologram plane 220. The diffraction component may be expressed by integration models, as shown in Table 2. Here, the diffraction component may correspond to a diffraction component with respect to light wave transfer in which all points on the 3D object plane 210 affect a single point on the hologram plane 220.

TABLE 2

| Light Wave Transfer Modeling | Integral Equation |
|---|---|
| Kirchhoff-Rayleigh-Sommerfeld Integral Transform | $α ( \vec{x} ) = {\int }_{- ∞}^{∞} a ( \vec{x} ) \frac{{e}^{j {2}_{π} \frac{\vec{x} \sqrt{1 + \vert \vert \vec{x} - \vec{f} {\vert \vert}^{2} \text{/} {z}^{2}}}{λ}}}{1 + \vert \vert \vec{x} - \vec{f} {\vert \vert}^{2} \text{/} {z}^{2}} d \vec{x}$ |
| Fresnel Integral Transform | $α ( \vec{x} ) = {\int }_{- ∞}^{∞} a ( \vec{x} ) {e}^{{j}_{π} \frac{\vert \vert \vec{x} - \vec{f} {\vert \vert}^{2}}{{λ}^{2}}} d \vec{x}$ |
| Angular Spectrum Transfer Transform | $α ( \vec{x} ) = {\int }_{- ∞}^{∞} [ {\int }_{- ∞}^{∞} a ( \vec{x} ) {e}^{j {2}_{π} \vec{x} \vec{f}} d \vec{x} ] {e}^{- {j}_{πλ} \vec{x} {\vec{f}}^{2}} {e}^{- j \vec{x} \vec{f}} d \vec{\int }$ |
| Fourier Integral Transform | $α ( \vec{x} ) = {\int }_{- ∞}^{∞} a ( \vec{x} ) {e}^{- {j}_{π} \frac{\vec{x} \vec{f}}{{λ}^{2}}} d \vec{x}$ |

In a process of processing hologram data, hologram fringe data may be computed by applying diffraction transform algorithms to the model data of the 3D object. The diffraction transform algorithms may include a Kirchhoff-Rayleigh-Sommerfeld Integral Transform algorithm, a Fresnel Integral Transform algorithm, an Angular Spectrum Transfer Transform algorithm, a Fourier Integral Transform algorithm, and the like.

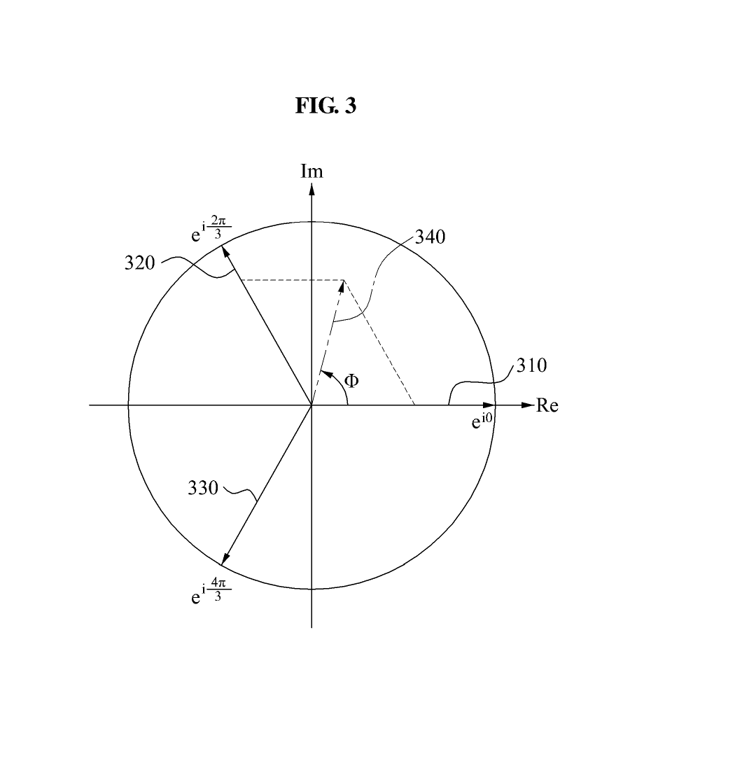

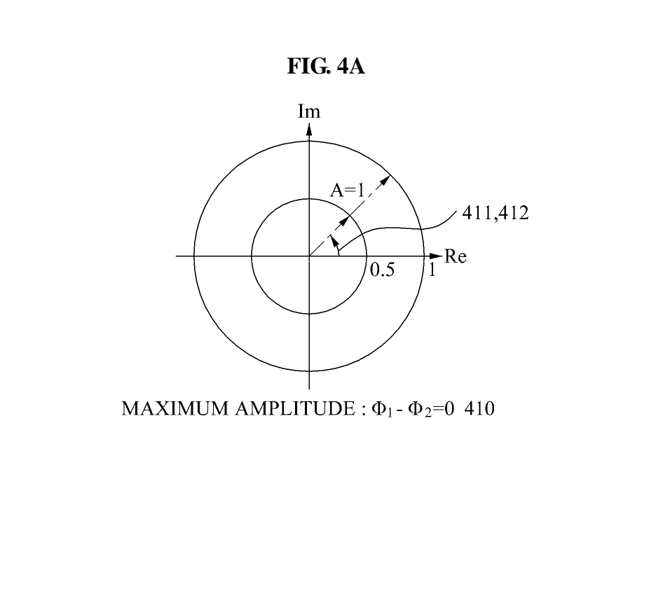

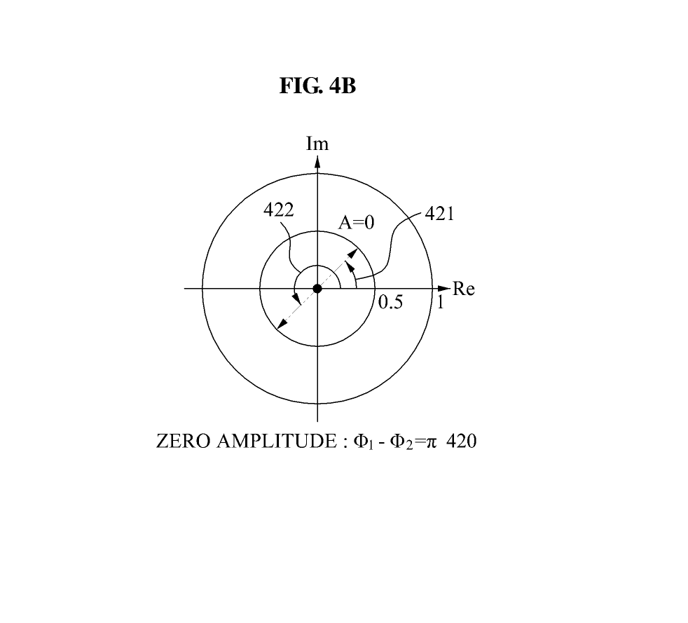

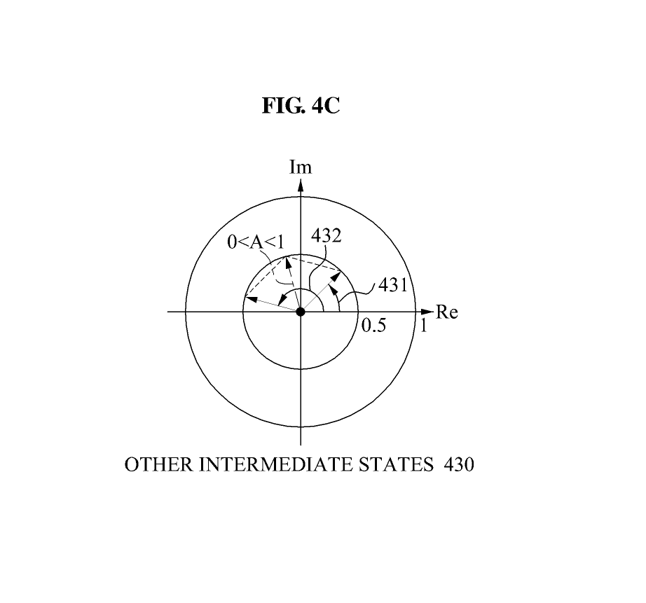

In addition, a hologram data format adaptive to a data encoding scheme may be set in the computed hologram fringe data. In this example, the data encoding scheme to be applied to the hologram fringe data may be performed by a spatial light modulator (SLM), using an amplitude encoding scheme or a phase encoding scheme depending on a characteristic of the SLM. The amplitude encoding scheme and the phase encoding scheme will be described in detail with reference to FIGS. 3 and 4, respectively.

FIG. 3 is a diagram illustrating an amplitude encoding scheme according to an embodiment of the present invention.

Referring to FIG. 3, the amplitude encoding scheme may be provided by obtaining an amplitude transmittance H of a hologram using a sum of three phase vectors, for example, a first phase vector 310, a second phase vector 320, and a third phase vector 330 at

$$\frac{2 π}{3}$$

intervals, as expressed by Equation 2.

$$H = {A}_{1} ( x , y ) {e}^{i 0} + {A}_{2} ( x , y ) {e}^{i \frac{2 π}{3}} + {A}_{3} ( x , y ) {e}^{i \frac{4 π}{3}} \qquad [ Equation 2 ]$$

For example, when A₃(x,y)=0 is satisfied at the third phase vector 330, the amplitude transmittance H may be expressed using a sum 340 of the first phase vector 310 and the second phase vector 320 that are adjacent to each other based on locations of phase angles.

FIGS. 4A through 4C are diagrams illustrating a phase encoding scheme according to an embodiment of the present invention.

Referring to FIGS. 4A through 4C, the phase encoding scheme may be provided by normalizing an amplitude to a predetermined size, dividing the normalized amplitude by ½, and obtaining an amplitude transmittance H of a hologram, as expressed by Equation 3.

$$\begin{matrix}H = {A}_{1} ( x , y ) {e}^{i Φ ( x , y )} \\ = \frac{1}{2} {e}^{i {Φ}_{2} ( x , y )} + \frac{1}{2} {e}^{i {Φ}_{2} ( x , y )} \\ = cos \frac{{Φ}_{1} ( x , y ) - {Φ}_{2} ( x , y )}{2} {e}^{i \frac{{Φ}_{2} ( x , y ) - {Φ}_{3} ( x , y )}{2}}\end{matrix} \qquad [ Equation 3 ]$$

An amplitude A may be classified, based on a difference between values of two phases φ₁ and φ₂, into a productive overlapping state 410, a destructive overlapping state 420, and other intermediate states 430. In the productive overlapping state 410, two phases φ₁ 411 and φ₂ 412 may overlap in an identical direction and thus, a maximum amplitude A may obtained. In the deconstructive overlapping state 420, two phases φ₁ 421 and φ₂ 422 may overlap in directions of which a difference corresponds to π and thus, an amplitude A of “0” may be obtained. In the other intermediate states 430, an amplitude A ranging between “0” and “1” may be obtained based on two phases φ₁ 431 and φ₂ 432.

In this instance, values of the two divided phases with respect to the amplitude transmittance H may be expressed by Equation 4 and Equation 5.

φ₁(x,y)=φ(x,y)+cos^{-1[}A(x,y)] [Equation 4]

φ₂(x,y)=φ(x,y)−cos⁻¹[A(x,y)] [Equation 5]

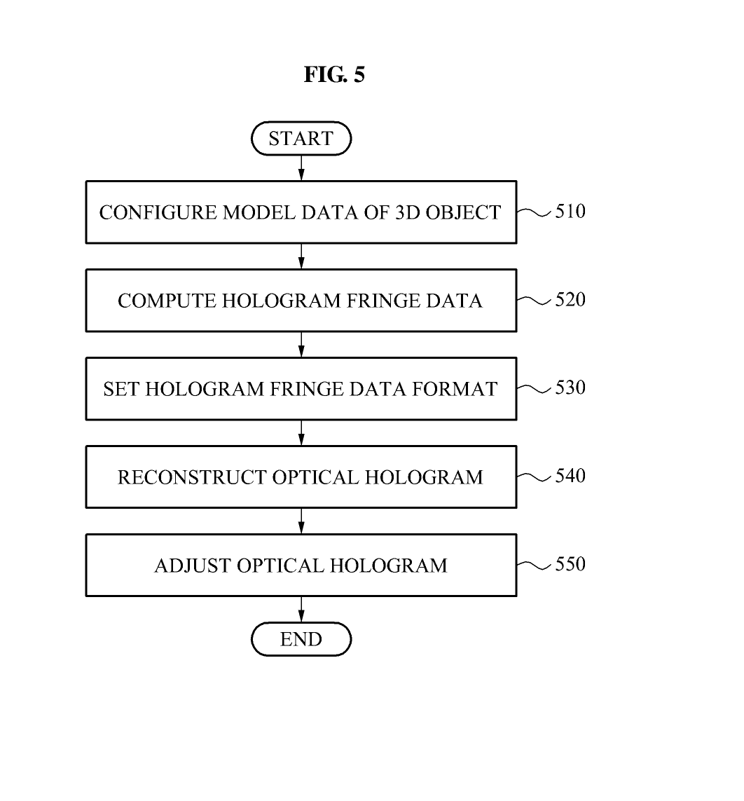

FIG. 5 is a flowchart illustrating a hologram data processing method using a hologram fringe data format adaptive to a data encoding scheme according to an embodiment of the present invention.

Referring to FIG. 5, in operation 510, model data of a 3D object corresponding to source data to be used for generating a hologram may be configured. In this instance, information on a scheme of configuring the model data of the 3D object may include information on a point cloud modeling scheme or information on a polygon mesh modeling scheme.

In operation 520, hologram fringe data may be computed by applying a diffraction transform with respect to a light wave transferred to a hologram plane based on the model data of the 3D object.

In operation 530, a hologram fringe data format adaptive to a data encoding scheme for reconstructing the hologram may be set in the computed hologram fringe data. In this instance, the process of setting the hologram fringe data format adaptive to the data encoding scheme may correspond to a process of setting a hologram fringe data format adaptive to both an amplitude encoding scheme and a phase encoding scheme, by incorporating both information on amplitude data of the hologram and information on phase data of the hologram into the hologram fringe data format. Here, the hologram fringe data format may further include header information including a hologram generation parameter and start bit information of hologram fringe data. The information on the amplitude data of the hologram may include start bit string information on the amplitude data of the hologram, amplitude data type information of the hologram, bit length information of an amplitude data stream of the hologram, and amplitude data stream information of the hologram. The information on the phase data of the hologram may include start bit string information on the phase data of the hologram, phase data type information of the hologram, bit length information of a phase data stream of the hologram, and phase data stream information of the hologram. The header information including the hologram generation parameter may include information on a 3D model data configuration scheme, information on a reference beam, information on a hologram fringe pattern data generation parameter, information on a hologram reproduction scheme, and information on an optical parameter.

In operation 540, an optical hologram may be reconstructed by applying the data encoding scheme to the hologram fringe data. In particular, the optical hologram may be reconstructed by loading the hologram fringe data on an SLM supporting at least one of the amplitude encoding scheme and the phase encoding scheme, and applying a reference beam to the SLM.

In operation 550, the optical hologram may be adjusted by comparing a reconstructed image of the optical hologram to a reconstructed image of a numerical hologram. In particular, the optical hologram may be adjusted in a direction in which the reconstructed image of the optical hologram matches the reconstructed image of the numerical hologram. In addition, the hologram fringe data may be re-computed by adjusting the hologram generation parameter. The optical hologram may be reconstructed again by applying the data encoding scheme to the re-computed hologram fringe data. In the process of comparing the reconstructed image of the optical hologram to the reconstructed image of the numerical hologram, an object quality assessment or a subjective quality assessment may be performed, and human factor elements may be investigated.

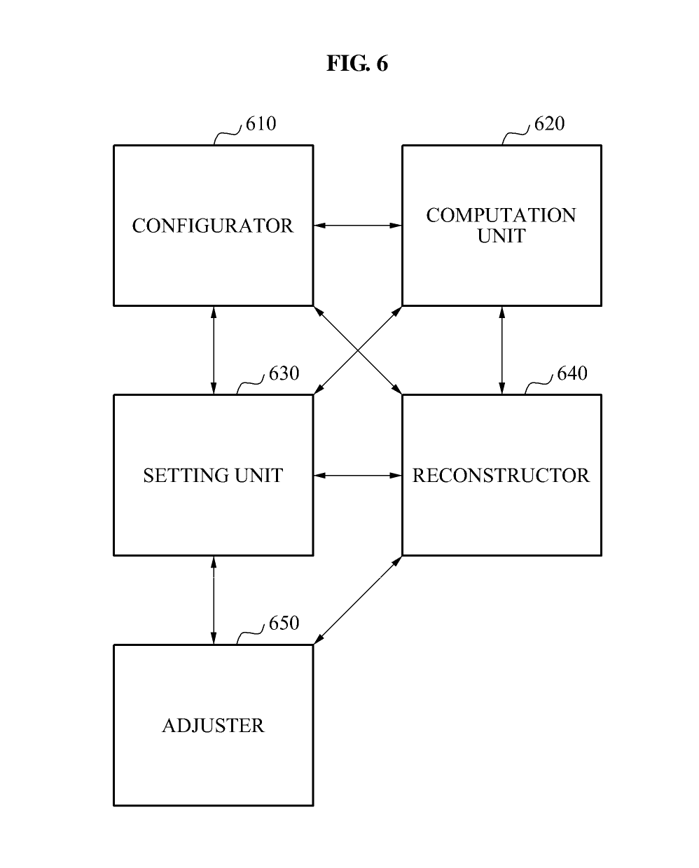

FIG. 6 is a block diagram illustrating a hologram data processing system using a hologram fringe data format adaptive to a data encoding scheme according to an embodiment of the present invention.

Referring to FIG. 6, the hologram data processing system may include a configurator 610, a computation unit 620, a setting unit 630, a reconstructor 640, and an adjuster 650.

The configurator 610 may configure model data of a 3D object corresponding to source data to be used for generating a hologram.

The computation unit 620 may compute hologram fringe data by applying a diffraction transform to a light wave transferred to a hologram plane based on the model data of the 3D object.

The setting unit 630 may set, in the computed hologram fringe data, the hologram fringe data format adaptive to a data encoding scheme for reconstructing the hologram.

In addition, the setting unit 630 may set a hologram fringe data format adaptive to both an amplitude encoding scheme and a phase encoding scheme, by incorporating information on phase data of the hologram and information on amplitude data of the hologram into the hologram fringe data format.

The reconstructor 640 may reconstruct an optical hologram by applying the data encoding scheme to the hologram fringe data.

The adjuster 650 may adjust the optical hologram by comparing a reconstructed image of the optical hologram to a reconstructed image of a numerical hologram.

The units described herein may be implemented using hardware components, software components, or a combination thereof. For example, a processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more non-transitory computer readable recording mediums.

The non-transitory computer readable recording medium may include any data storage device that can store data which can be thereafter read by a computer system or processing device. Examples of the non-transitory computer readable recording medium include read-only memory (ROM), random-access memory (RAM), CD-ROMs, magnetic tapes, floppy disks, and optical data storage devices. Also, functional programs, codes, and code segments for accomplishing the example embodiments disclosed herein can be easily construed by programmers skilled in the art to which the embodiments pertain based on and using the flow diagrams and block diagrams of the figures and their corresponding descriptions as provided herein.

According to exemplary embodiments of the present invention, there is provided a method, apparatus, and system that may define a data format for storing hologram fringe data.

According to exemplary embodiments of the present invention, there is also provided a method, apparatus, and system that may set a hologram fringe data format adaptive to a data encoding scheme, by defining a data format adaptive to both an amplitude encoding scheme and a phase encoding scheme in a process of processing hologram data.

According to exemplary embodiments of the present invention, there is further provided a method, apparatus, and system that may define a data format to adjust an optical hologram by comparing a reconstructed optical hologram to a numerical hologram in a process of processing hologram data.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of processing hologram data using a hologram fringe data format adaptive to a data encoding scheme, the method comprising:
configuring model data of a three-dimensional (3D) object corresponding to source data to be used for generating a hologram;
computing hologram fringe data by applying a diffraction transform to a light wave transferred to a hologram plane based on the model data of the 3D object;
setting, in the computed hologram fringe data, the hologram fringe data format adaptive to a data encoding scheme for reconstructing the hologram;
reconstructing an optical hologram by applying the data encoding scheme to the hologram fringe data; and
adjusting the optical hologram by comparing a reconstructed image of the optical hologram to a reconstructed image of a numerical hologram.

2. The method of claim 1, wherein the setting comprises setting a hologram fringe data format adaptive to both an amplitude encoding scheme and a phase encoding scheme, by incorporating information on phase data of the hologram and information on amplitude data of the hologram into the hologram fringe data format.

3. The method of claim 2, wherein the information on the amplitude data of the hologram comprises start bit string information on the amplitude data of the hologram, amplitude data type information of the hologram, bit length information of an amplitude data stream of the hologram, and amplitude data stream information of the hologram.

4. The method of claim 2, wherein the information on the phase data of the hologram comprises start bit string information on the phase data of the hologram, phase data type information of the hologram, bit length information of a phase data stream of the hologram, and phase data stream information of the hologram.

5. The method of claim 2, wherein the hologram fringe data format further comprises header information comprising a hologram generation parameter and start bit information of the hologram fringe data.

6. The method of claim 5, wherein the header information comprises information on a 3D model data configuration scheme, information on a reference beam, information on a hologram fringe pattern data generation parameter, information on a hologram reproduction scheme, and information on an optical parameter.

7. The method of claim 1, wherein the adjusting comprises adjusting the optical hologram in a direction in which the reconstructed image of the optical hologram matches the reconstructed image of the numerical hologram.

8. The method of claim 7, wherein the adjusting comprises re-computing the hologram fringe data by adjusting a hologram generation parameter.

9. A method of setting a hologram fringe data format adaptive to a data encoding scheme, the method comprising:
configuring model data of a three-dimensional (3D) object corresponding to source data to be used for generating a hologram;
computing hologram fringe data by applying a diffraction transform to a light wave transferred to a hologram plane based on the model data of the 3D object; and
setting, in the computed hologram fringe data, the hologram fringe data format adaptive to a data encoding scheme for reconstructing the hologram.

10. The method of claim 9, wherein the setting comprises setting a hologram fringe data format adaptive to both an amplitude encoding scheme and a phase encoding scheme, by incorporating information on amplitude data of the hologram and information on phase data of the hologram into the hologram fringe data format.

11. A system for processing hologram data using a hologram fringe data format adaptive to a data encoding scheme, the system comprising:
a configurator to configure model data of a three-dimensional (3D) object corresponding to source data to be used for generating a hologram;
a computation unit to compute hologram fringe data by applying a diffraction transform to a light wave transferred to a hologram plane based on the model data of the 3D object;
a setting unit to set, in the computed hologram fringe data, the hologram fringe data format adaptive to a data encoding scheme for reconstructing the hologram;
a reconstructor to reconstruct an optical hologram by applying the data encoding scheme to the hologram fringe data; and
an adjuster to adjust the optical hologram by comparing a reconstructed image of the optical hologram to a reconstructed image of a numerical hologram.

12. The system of claim 11, wherein the setting unit sets a hologram fringe data format adaptive to both an amplitude encoding scheme and a phase encoding scheme, by incorporating information on phase data of the hologram and information on amplitude data of the hologram into the hologram fringe data format.

13. A system for setting a hologram fringe data format adaptive to a data encoding scheme, the system comprising:
a configurator to configure model data of a three-dimensional (3D) object corresponding to source data to be used for generating a hologram;
a computation unit to compute hologram fringe data by applying a diffraction transform to a light wave transferred to a hologram plane based on the model data of the 3D object; and
a setting unit to set, in the computed hologram fringe data, the hologram fringe data format adaptive to a data encoding scheme for reconstructing the hologram.
